(19) United States
(12) Patent Application Publication
(10) Pub. No.: US 2013/0097340 A1
(43) Pub. Date: Apr. 18, 2013

(54) USB MULTI-FUNCTIONS DEVICE AND METHOD THEREOF

(71) Applicant: Po-Hung Chen, Taipei City (TW)

(72) Inventor: Po-Hung Chen, Taipei City (TW)

(73) Assignee: MEDIATEK INC., Hsin-Chu (TW)

(21) Appl. No.: 13/275,512

(22) Filed: Oct. 18, 2011

(51) Int. Cl. G06F 3/00

(52) U.S. Cl. 710/10; 710/8

(57) ABSTRACT

A USB multi-functions device and a method thereof. The USB multi-functions device is capable of supporting a plurality of functions for a USB host, has a first software module installed to support a first selection of the functions, and comprises a function switch, a memory, and a controller. The function switch receives an input signal unrelated to any previous signal to switch from the first to a second selection of functions. The memory comprises a switch program executable by a controller, the first software module supporting the first selection of the functions and a second software module supporting the second selection of the functions. The controller executes the switch program to determine the second selection of the functions based on the input signal, and installs the second software module.

### BACKGROUND OF THE INVENTION

1. Field of the Invention

The present invention relates to a Universal Serial Bus (USB) multi-functions device, and in particular relates to a USB multi-functions device, in which a user can switch between functions or groups of functions using a function switch.

2. Description of the Related Art

The Universal Serial Bus (USB) is a cable bus that supports data exchange between a USB host computer and a wide range of simultaneously accessible USB peripheral devices. The attached peripheral devices share USB bandwidth through a host-scheduled, token-based protocol. The USB bus allows peripherals to be attached, configured, used, and detached while the host and other peripherals are in operation.

Conventional design, such as USB composite device, is a USB peripheral device capable of supporting multiple functions, such as a network card, a CD-ROM, and a flash disk, to the USB host computer simultaneously. However, not all of operating system supports this type of device so the operating system would run longer scanning time to find which type of functions it support. Another conventional design, such as a host-aid solution, requires to run a guide program, this consumes extra effort for system to execute the guide program for operating system and consume extra effort for user to send extra singe commanding USB device to switch function. Another conventional design, such as auto-run USB multi-function device, is actually to execute and/or install program into operating system to automatically show the program to let user for select which functions operating system supports and which functions user would like to utilize at the present time. However, none of this device can easily let user directly command which function they would like to ask operating system executing immediately without waiting for further instructions from operating system. Thus, a user-friendly interface for switching between functions provided by a USB multi-functions device is required.

### BRIEF SUMMARY OF THE INVENTION

A detailed description is given in the following embodiments with reference to the accompanying drawings.

An embodiment of a USB multi-functions device is disclosed, capable of supporting a plurality of functions for a USB host, having a first software module installed to support a first selection of the functions, comprising a function switch, a memory, and a controller. The function switch receives an input signal unrelated to any previous signal to switch from the first to a second selection of the functions. The memory comprises a switch program executable by a controller, the first software module supporting the first selection of the functions and a second software module supporting the second selection of the functions. The controller executes the switch program to determine the second selection of the functions based on the input signal, and installs the second software module.

Another embodiment of a method for a USB multi-functions device is provided, supporting a plurality of functions for a USB host, comprising a function switch receiving an input signal unrelated to any previous signal to switch from a first to a second selection of the functions, a memory storing a switch program, a first software module supporting the first selection of the functions and a second software module supporting the second selection of the functions, a controller executing the switch program to determine the second selection of the functions based on the input signal, and the controller installing the second software module.

### BRIEF DESCRIPTION OF THE DRAWINGS

The present invention can be more fully understood by reading the subsequent detailed description and examples with references made to the accompanying drawings, wherein:

FIG. 1 is a block diagram of an exemplary USB system 1 comprising a USB host 10 and a USB multi-functions device 12 according to an embodiment of the invention;

FIG. 2 is a flowchart of an exemplary function switch method 2 for a USB multi-functions device according to an embodiment of the invention; and

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

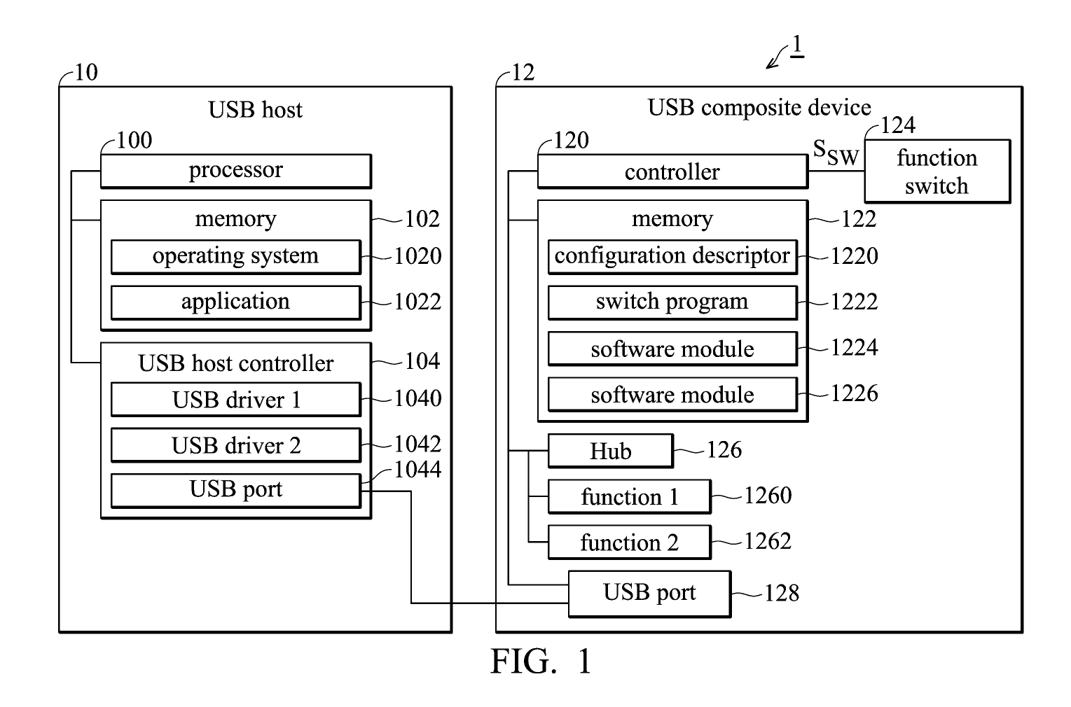

FIG. 1 is a block diagram of an exemplary USB system 1 comprising a USB host 10 and a USB multi-functions device 12 according to an embodiment of the invention. The USB host 10 may be a personal computer and comprises a processor 100, a memory 102, and a USB host controller 104. The processor 100 is coupled to the memory 102 and the USB host controller 104, and controls operations thereof. The USB multi-functions device 12 comprises a controller 120, a memory 122, a function switch 124, a hub 126, and a USB port 128. The controller 120 is coupled to the memory 122, the function switch 124, the hub 126, and the USB port 128, and controls operations thereof.

The memory 102 in the USB host 10 comprises an operation system 1020, and various applications 1022 that run on the operation system 1020. The operation system 1020 provides system services to the application 1020 and support USB services to the USB host controller 104, and may be a Microsoft Windows family, Linux family, MAC OS family, or the like. The application 1022 is a software program with functions required by a user including a word processing program, a music playback program, or an image processing program. The USB host controller 104 comprises memory modules (not shown) storing USB drivers 1040 and 1042 for communication with the USB device 12, a USB port 1044 exchanging data and commands with the USB device 12, and logic circuits (not shown) controlling USB host operations. The application 1022 makes application level calls to the system services provided by the operation system, whereas the system services take care of lower level communication details with the USB device 12 through the USB driver 1040 or the USB driver 1042 and return requested information to the corresponding application 1022.

The USB multi-functions device 12 is a multi-function device with multiple, independent interfaces defined by interface descriptors stored therein. A multi-functions device may declare itself to have more than one function at the same time in a single USB configuration file. The USB multi-functions device 12 has at least one address on the bus and each interface has a different function and a predetermined device driver thereof A function referred herein is a device that provides a capability to the USB host, including a keyboard, a mouse, a speaker, a display, an emulated CD-ROM, or a network adaptor. In some embodiment, the composite USB Characteristic can actually be one of functions of the USB multi-functions device 12 in the present invention. In the embodiment, the USB multi-functions device 12 has one interface for a network card (function 1) and another interface for an emulated CD (function 2). Each interface has an interface descriptor thereof. The USB host 10 may load a driver for each interface either from the USB multi-functions device 12 or from the local memory.

The memory 122 comprises a configuration descriptor 1220, a switch program 1222, a software module 1224 for function 1 and a software module 1226 for function 2 that are accessible and executable by the controller 120. The software module may be a linux kernel or Microsoft Windows software module supporting a specific USB function. The memory 122 may be any type of computer-readable memory media including electronic memory, magnetic storage media, optical storage media, or any other type of data storage. The configuration descriptor 1220 specifies attributes including power consumption of the configuration, power sources of each device and the number of interfaces the configuration has. When more than one function is specified in the configuration descriptor 1220, the USB host 10 can identify the USB device 12 as a USB multi-functions device. The USB device 12 may have more than one configuration descriptor 1220, and the USB host 10 can obtain all configurations and makes a decision on which configuration to enable, wherein only one configuration may be enabled at a time.

In the embodiment in FIG. 1, the USB multi-functions device comprises two functions, i.e., a function 1 and a function 2. The hub 126 is coupled to a block 1260 for the function 1 and a block 1262 for the function 2. The function blocks 1260 and 1262 may be a hardware device such as a USB flash drive or emulated software such as an emulated CD-ROM. The USB multi-functions device 12 communicates with the USB host 10 through the USB port 128. Similarly, the USB host 10 performs data transmission with the USB multi-functions device through a USB port 1044.

Conventionally, the USB host 10 may load multiple devices on the USB device 12 at once, either automatically or through a guide program at the USB host. In the present invention, the USB multi-functions device 12 employs the function switch 124 in conjunction with the switch program 1222 to select and determine the required function or required selection of functions. The function switch 124 may be a hardware switch, a button, or a touch display that receives a non-interactive input signal unrelated or irrelevant to any previous signals from a user when a device function switch is required. For example, the function switch may be a push button that a user may push to alternately switch between the network card function and the emulated CD function provided by the multi-functions device 12. Upon detecting the non-interactive input signal, the function switch 124 responsively generates an input interrupt signal S_{sw} to inform the controller 120 about the function change. The controller 120 loads the switch program 1222 that comprises instruction codes for the USB multi-functions device 12 to switch between functions or groups of functions defined by a developer or a vendor. In the switch program 1222, a predetermined function or group of functions may be defined to be selected based on the non-interactive input signal, wherein only one thereof can be selected at a time. In one embodiment, three groups of functions are defined as an emulated CD-ROM (function 1), a network card (function 2), and the emulated CD-ROM plus the network card, and the controller 120 selects each group in cyclic order when a user enters a non-interactive input signal at the function switch 124. The non-interactive input signal may be, for example, a long press on the function switch 124 exceeding a predetermined duration, a predetermined number of presses, a predetermined pattern of a press, and press patterns different from one another, wherein each press pattern represent a predetermined function or group of functions. The software modules 1224 and 1226 are software supporting the function 1 and the function 2, e.g., software modules 1224 and 1226 may be linux kernel modules supporting the function 1 and function 2, respectively. The USB multi-functions device 12 may be in communication with the USB host 10 with respect to a specific function using a corresponding software module. Although only two software modules are illustrated in FIG. 1, those skilled in the art will appreciate that more software modules may be incorporated in the USB multi-functions device 12 to support more than two functions.

Upon attachment, the USB host 10 first requests the USB device 12 to indicate supportability of multiple functions or logical devices (LDs). In response, the USB multi-functions device 12 returns the supportability information to the USB host 10 by first identifying the number of logical devices that the device supports in the single USB configuration descriptor 1220. Next, to obtain specific information corresponding to each supported LD, the USB host 10 issues separate requests, wherein each request is overloaded with a respective LD identification, to obtain each respective LD descriptor. After power on, the controller 120 may load the switch program 1222 to determine the function switch. The USB host 10 may load the corresponding drivers either from a local data storage device or Internet to communicate with the USB device 12. The function switch 124 continuously monitors whether there is any input signal. Upon detecting the input signal, the controller 120 executes the switch program 1222 to determine the selection of functions.

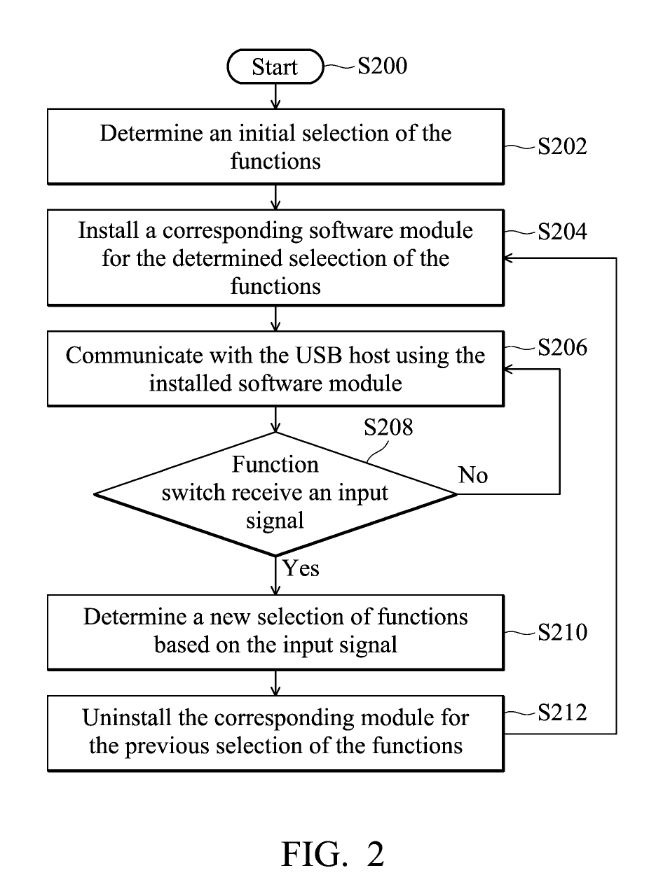

FIG. 2 is a flowchart of an exemplary function switch method 2 for a USB multi-functions device according to an embodiment of the invention, incorporating the USB system 1 in FIG. 1. Upon start (S200), the USB multi-functions device 12 is attached to the USB host 10 and the controller 120 executes the switch program 1222 to determine an initial selection of the functions (S202). The controller 120 then searches for a corresponding software module for the initial selection of the functions from the memory 122 and installs the corresponding software module. The software module may be a linux kernel software module supporting a specific USB function. After the installation, the USB multi-functions device 12 can communicate with the USB host 10 using the installed software module (S206). For example, the controller 120 determines an emulated CDROM as the initial selection of the function, and finds the corresponding software module that supports the emulated CDROM from a number of software modules at memory 122 for installation, so that the USB multi-functions device 12 can communicate with the USB host 10 through the installed software module. When the data communication between the USB host 10 and the USB multi-functions device 12 is proceeding, concurrently the function switch 124 determines whether an input signal has been entered by a user (S208). If so, the controller 120 executes the switch program 1222 to switch the selection of the function from the initial selection (first selection) to a new selection (second selection) based on the input signal (S210). Otherwise, the controller 120 continues to perform the data communication with the USB host 10 (S206). When the new selection of functions has been determined, the controller 120 uninstalls the corresponding software module for the initial selection of the functions (previous selection) (S212), and installs the corresponding software module for the determined selection of function (the new selection) (S204), so that the USB host 10 can access the new selection of the functions at the USB multi-functions device 12.

The present invention employs a function switch in conjunction with a switch program to provide a user-friendly interface for a user to switch between functions in a USB multi-functions device.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A USB multi-functions device, capable of supporting a plurality of functions for an USB host, having a first software module installed to support a first selection of the functions, comprising:
a function switch, receiving an input signal unrelated to any previous signal to switch from the first to a second selection of the functions;
a memory, comprising a switch program executable by a controller, the first software module supporting the first selection of the functions and a second software module supporting the second selection of the functions; and
the controller, executing the switch program to determine the second selection of the functions based on the input signal, and installing the second software module.

2. The USB multi-functions device of claim 1, wherein the controller further uninstalls the first software module.

3. The USB multi-functions device of claim 1, wherein the controller further determines an initial selection of the functions upon power-on, and installs a corresponding software module to support the initial selection of the functions.

4. The USB multi-functions device of claim 1, wherein the controller determines to switch the first and second selections of the functions in a cyclic order upon receiving the input signal.

5. The USB multi-functions device of claim 1, wherein the first selection of the functions comprises only a first function of the plurality of functions.

6. The USB multi-functions device of claim 1, wherein and the second selection of the functions comprises only a second function of the plurality of functions.

7. The USB multi-functions device of claim 1, wherein the first selection of the functions comprises a first combination of the plurality of functions.

8. The USB multi-functions device of claim 1, wherein the second selection of the functions comprises a second combination of the plurality of functions.

9. A method for a USB multi-functions device supporting a plurality of functions for a USB host, comprising:
a function switch receiving an input signal unrelated to any previous signal to switch from a first to a second selection of the functions;
a memory storing a switch program, a first software module supporting the first selection of the functions and a second software module supporting the second selection of the functions;
a controller executing the switch program to determine the second selection of the functions based on the input signal; and
the controller installing the second software module.

10. The method of claim 9, further comprising the controller uninstalling the first software module.

11. The method of claim 9, further comprising the controller determining an initial selection of the functions upon power-on, and installing a corresponding software module to support the initial selection of the functions.

12. The method of claim 9, wherein the executing step comprises the controller executing the switch program to determine to switch the first and second selections of the functions in a cyclic order upon receiving the input signal.

13. The method of claim 9, wherein the first selection of the functions comprises only a first function of the plurality of functions.

14. The method of claim 9, wherein and the second selection of the functions comprises only a second function of the plurality of functions.

15. The method of claim 9, wherein the first selection of the functions comprises a first combination of the plurality of functions.

16. The method of claim 9, wherein the second selection of the functions comprises a second combination of the plurality of functions.
